(19) United States
(12) Patent Application Publication
(10) Pub. No.: US 2014/0130493 A1
(43) Pub. Date: May 15, 2014

(54) TURBOCHARGED MOTOR VEHICLE ENGINE SYSTEM AND METHOD

(71) Applicant: GM GLOBAL TECHNOLOGY OPERATIONS LLC, Detroit, MI (US)

(72) Inventors: Thomas A. Spix, Rochester Hills, MI (US); Neil G. Klueber, Rochester Hills, MI (US)

(73) Assignee: GM Global Technology Operations LLC, Detroit, MI (US)

(21) Appl. No.: 13/678,075

(22) Filed: Nov. 15, 2012

(51) Int. Cl. F02B 37/00; F02M 25/06; F02M 31/20

(52) U.S. Cl. CPC F02B 37/00; F02M 31/20; F02M 25/06
USPC 60/599; 60/605.2; 123/572; 123/542

(57) ABSTRACT

A turbocharged motor vehicle engine system includes an engine having an intake manifold, an exhaust manifold, and a crankcase ventilation outlet. A turbocharger includes a turbine having an inlet fluidly connected to the exhaust manifold through an exhaust conduit and a turbo compressor having an outlet fluidly connected to the intake manifold through an inlet conduit. The turbo compressor also includes an inlet. A crankcase gas conditioning member includes an inlet section fluidly connected to the crankcase ventilation outlet and an outlet section fluidly connected to the turbo compressor inlet. An idle bypass conduit includes an inlet portion fluidly connected to the outlet section of the crankcase gas conditioning member and an outlet portion fluidly connected to the inlet conduit. The idle bypass conduit is configured and disposed to selectively bypass the turbo charger while the engine is operating at an idle.

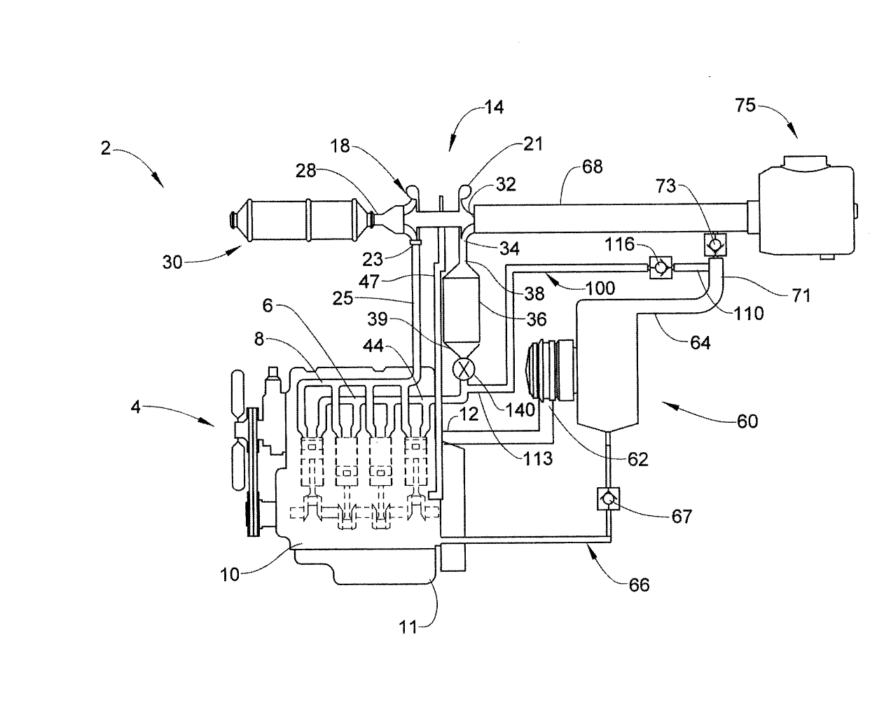

### FIELD OF THE INVENTION

The subject invention relates to the art of motor vehicles and, more particularly, to a turbocharged motor vehicle engine system and a method.

### BACKGROUND

Many motor vehicles employ diesel engines that provide higher torque and greater fuel economy than comparative gas powered engines. Many diesel engines are provided with a turbocharger. The turbocharger increases power output, reduces emissions, and improves efficiency of the diesel engine. Generally, a turbocharger is driven by exhaust gases to form compressed ambient air that is delivered to an intake manifold of the diesel engine. The compressed air provides a greater mass flow of air into the diesel engine leading to increased power. Turbocharger efficiency is reduced by carbon build up on internal working components.

Carbon build-up or coking may be caused by oil leaking into a compressor portion of the turbocharger. The oil is heated by exhaust gases and carbonized. Generally, oil migrates into the compressor portion during idle when crankcase pressure is higher than intake pressure. Many vehicles, such as trucks, ambulances and the like, idle for prolonged periods. During normal operating conditions, crankcase pressure is greater than inlet pressure of the turbocharger and oil leakage is minimal at best. However, during idle, exhaust gases are not sufficient to drive the compressor at speed, and crankcase pressure and inlet pressure of the turbocharger equalize. As such, pressure is reduced on internal turbocharger seals and oil tends to leak into the compressor. Such an operating state leads to turbocharger fouling resulting in reduced efficiency and the need for increased maintenance cycles. Accordingly, it is desirable to provide a throttle system that enables a turbocharger to operate during prolonged idle without being subjected to fouling and or coking.

### SUMMARY OF THE INVENTION

In accordance with an exemplary embodiment, a turbocharged motor vehicle engine system includes an engine having an intake manifold, an exhaust manifold, and a crankcase ventilation outlet. A turbocharger includes a turbine having an inlet fluidly connected to the exhaust manifold through an exhaust conduit and a turbo compressor having an outlet fluidly connected to the intake manifold through an inlet conduit. The turbo compressor also includes an inlet. A crankcase gas conditioning member includes an inlet section fluidly connected to the crankcase ventilation outlet and an outlet section fluidly connected to the turbo compressor inlet. An idle bypass conduit includes an inlet portion fluidly connected to the outlet section of the crankcase gas conditioning member and an outlet portion fluidly connected to the inlet conduit. The idle bypass conduit is configured and disposed to selectively bypass the turbo charger while the engine is operating at an idle.

In accordance with another exemplary embodiment, a method of operating a turbocharged engine includes operating the turbocharged engine in a first mode in which crankcase ventilation gases pass from a crankcase to an intake manifold through a turbo compressor, and operating the turbocharged engine in a second mode in which the crankcase ventilation gases pass from the crankcase through an idle bypass conduit directly to the intake manifold bypassing the turbo compressor.

The above features and advantages and other features and advantages of the invention are readily apparent from the following detailed description of the invention when taken in connection with the accompanying drawing.

### BRIEF DESCRIPTION OF THE DRAWING

Other features, advantages and details appear, by way of example only, in the following detailed description of embodiments, the detailed description referring to the drawing in which:

The FIGURE depicts a schematic view of a turbocharged engine system in accordance with an exemplary embodiment.

### DESCRIPTION OF THE EMBODIMENTS

A turbocharged engine system in accordance with an exemplary embodiment is indicated generally at 2 in the figure. Turbocharged engine system 2 includes an internal combustion engine 4. Engine 4 takes the form of a diesel engine however, it should be understood, that engine 4 may take on other forms. Engine 4 includes an intake manifold 6, an exhaust manifold 8, a crankcase 10 and a sump or oil pan 11. Crankcase 10 includes a crankcase ventilation (CCV) outlet 12. Turbocharged engine system 2 is also shown to include a turbocharger 14 coupled to engine 4. The following description is merely exemplary in nature and is not intended to limit the present disclosure, its application or uses. It should be understood that throughout the drawing, corresponding reference numerals indicate like or corresponding parts and features.

Turbocharger 14 includes a turbine 18 operatively connected to a turbo compressor 21. Turbine 18 includes an inlet 23 fluidly connected to exhaust manifold 8 through an exhaust conduit 25 and an outlet 28 fluidly connected to an exhaust system 30. Turbo compressor 21 includes an inlet 32 and an outlet 34. Outlet 34 is fluidly connected to intake manifold 6 through heat exchanger 36. Heat exchanger 36 includes a heat exchanger inlet 38 coupled to outlet 34 of turbo compressor 21 and a heat exchanger outlet 39 that connects with intake manifold 6 through an inlet conduit 44. Turbocharger 14 also includes an oil drain line 47 that is fluidly connected to crankcase 10. Oil drain line 47 allows oil in turbocharger 14 to flow back into sump 11 to be redistributed in engine 4. Turbocharged engine system 2 is also provided with a crankcase gas conditioning member 60.

Crankcase gas conditioning member 60 separates oil contained within crankcase gases to reduce emissions from engine 4. Crankcase gas conditioning member 60 includes an inlet section 62 fluidly connected to CCV outlet 12, an outlet section 64, and an oil drain line 66. Crankcase gases from CCV outlet 12 enter into crankcase gas conditioning member 60, oil is separated from the crankcase gases and passed back to crankcase 10 through oil drain line 66. A check valve 67 prevents any backflow of oil or crankcase gases into crankcase gas conditioning member 60. Once the oil is separated, cleaner crankcase gases pass from outlet section 64 and flow into an intake conduit 68 through a passage 71. Intake conduit 68 is fluidly connected with inlet 32 of turbo compressor 21. A one-way valve 73 prevents backflow of gases into crankcase gas conditioning member 60. In a first mode of operation or when engine 4 is operated at above idle, crankcase gases exiting crankcase gas conditioning member 60 mix with intake air passing through an engine air intake filter 75 and flow through intake conduit 68 to turbo compressor 21.

In a second mode of operation, or idle mode, exhaust gases are insufficient to operate turbocharger 14 so as to maintain a desirable pressure differential in engine 4. As such, CCV flow into crankcase gas conditioning member 60 ceases, and crankcase pressure urges oil toward turbocharger 14 through oil drain line 47. The oil flowing towards turbocharger 14 tends to pass through seals (not shown) in turbine 18 and turbo compressor 21. The oil entering turbine 18 and turbo compressor 21 may carbonize causing a reduction in turbocharger efficiency. Accordingly, it is desirable to maintain a pressure differential in engine 4 during idle to prevent oil migration back through oil drain line 47.

In accordance with an exemplary embodiment, turbocharged engine system 2 includes an idle bypass conduit 100. Idle bypass conduit 100 includes an inlet portion 110 fluidly connected to passage 71 upstream from one-way check valve 73 and an outlet portion 113 that is fluidly connect to inlet conduit 44 downstream from heat exchanger outlet 39. A one-way valve 116 is provided in idle bypass conduit 100 to prevent a reverse flow when engine 4 is operating in the first mode. A throttle control member 140 controls flow through idle bypass conduit 100 when engine 4 is operated in the second or idle mode. Throttle control member 140 reduces flow through heat exchanger 36 and increases flow from crankcase gas conditioning member 60 .

When heat exchanger 36 is closed, crankcase ventilation gases exiting crankcase conditioning member 60 flow directly to intake manifold 6 bypassing intake conduit 68. The flow from crankcase conditioning member 60 maintains a negative pressure differential within engine 4. The negative pressure differential ensures that oil continues to flow from turbocharger 14 through oil drain line 47. The conditioned flow of oil reduces carbonization or coking build-up that occurs during idle. Reducing coking during idle is particularly helpful for vehicles that idle for prolonged periods. Incorporation of the present invention into a turbocharged engine system leads to a reduction in maintenance cycles allowing the engine to remain in operation for longer periods. In addition, passing crankcase ventilation gases through the intake provides an added benefit of further reducing emissions from engine 4.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. A turbocharged engine system comprising:
an engine including an intake manifold, an exhaust manifold, and a crankcase ventilation outlet;
a turbocharger including a turbine having an inlet fluidly connected to the exhaust manifold through an exhaust conduit and a turbo compressor having an outlet fluidly connected to the intake manifold through an inlet conduit, the turbo compressor also including an inlet;
a crankcase gas conditioning member including an inlet section fluidly connected to the crankcase ventilation outlet and an outlet section fluidly connected to the inlet of the turbo compressor; and
an idle bypass conduit including an inlet portion fluidly connected to the outlet section of the crankcase gas conditioning member and an outlet portion fluidly connected to the inlet conduit, the idle bypass conduit being configured and disposed to selectively bypass the turbocharger while the engine is operating at an idle creating a negative pressure differential in the engine.

2. The turbocharged engine system according to claim 1, further comprising: a throttle control member arranged in the inlet conduit between the outlet of the turbo compressor and the outlet of the idle bypass conduit.

3. The turbocharged engine system according to claim 2, further comprising: a heat exchanger fluidly connected to the inlet conduit, the heat exchanger including a heat exchanger inlet fluidly connected to the outlet of the turbo compressor and a heat exchanger outlet fluidly connected to the intake manifold.

4. The turbocharged engine system according to claim 3, wherein the throttle control member is positioned at the heat exchanger outlet.

5. The turbocharged engine system according to claim 1, further comprising: an intake air filter fluidically connected with the inlet of the turbo compressor.

6. The turbocharged engine system according to claim 1, further comprising: a one-way valve arranged in the idle bypass conduit.

7. The turbocharged engine system according to claim 6, further comprising: another one-way valve arranged down stream from the inlet of the turbo compressor and upstream of the inlet section of the idle bypass conduit.

8. The turbocharged engine system according to claim 7, wherein the another one-way valve is upstream of the outlet section of the crankcase gas conditioning member.

9. The turbocharged engine system according to claim 1, wherein the engine comprises a diesel engine.

10. A method of operating a turbocharged engine comprising:
operating the turbocharged engine in a first mode in which crankcase ventilation gases pass from a crankcase to an intake manifold through a turbo compressor; and
operating the turbocharged engine in a second mode in which the crankcase ventilation gases pass from the crankcase through an idle bypass conduit directly to the intake manifold bypassing the turbo compressor creating a negative pressure differential in the turbocharged engine.

11. The method of claim 10, further comprising: passing the crankcase ventilation gases through a crankcase gas conditioning member.

12. The method of claim 10, further comprising: preventing a flow of crankcase ventilation gases from the turbo compressor into the idle bypass conduit when operating in the second mode.

13. The method of claim 10, further comprising: preventing a flow of crankcase ventilation gases from the intake manifold through the idle bypass conduit when operating in the first mode.

14. The method of claim 10, further comprising: passing the crankcase ventilation gases from the turbo compressor through a heat exchanger arranged upstream of the intake manifold when operating in the first mode.

15. The method of claim 14, further comprising: bypassing the heat exchanger when operating in the second mode.

16. The method of claim 10, wherein operating in the second mode includes idling the turbocharged engine.

17. The method of claim 10, further comprising: mixing the crankcase ventilation gases with ambient air passing through an air filter when operating in the first mode.

18. The method of claim 17, further comprising: bypassing intake air mixing when operating in the second mode.

19. The method of claim 10, further comprising: passing oil from the turbocharger to the crankcase when operating in both the first and second mode.

20. The method of claim 10, wherein operating the turbocharged engine includes operating a diesel engine.
